(19) United States
(12) Patent Application Publication
(10) Pub. No.: US 2011/0171378 A1
(43) Pub. Date: Jul. 14, 2011

(54) METHOD FOR PRODUCING COVERED PARTICLES

(75) Inventors: Raitaro Masaoka, Tokyo (JP); Takashi Ota, Tokyo (JP); Hisayuki Abe, Tokyo (JP); Takeshi Sako, Hamamatsu-shi (JP); Chang Yi Kong, Hamamatsu-shi (JP); Idzumi Okajima, Hamamatsu-shi (JP); Takuya Murai, Hamamatsu-shi (JP)

(73) Assignees: TDK Corporation, Tokyo (JP); National University Corporation Shizuoka University, Shizuoka-shi (JP)

(21) Appl. No.: 12/985,621

(22) Filed: Jan. 6, 2011

(30) Foreign Application Priority Data
Jan. 13, 2010 (JP) 2010-004920

(51) Int. Cl. B05D 7/24

(52) U.S. Cl. 427/216; 427/215

(57) ABSTRACT

A method for producing covered particles, comprising: a mixing step of mixing a fluid containing particles comprising at least one type of substance selected from among metals, metal oxides and ceramics, a silsesquioxane having a functional group with an affinity for carbon dioxide, and supercritical carbon dioxide; and a covering step of reducing pressure of the fluid to gasify the supercritical carbon dioxide, while adhering the silsesquioxane onto the particles, and thereby obtaining covered particles comprising the particles and silsesquioxane covering the particles.

### BACKGROUND OF THE INVENTION

1. Field of the Invention

The present invention relates to a method for producing covered particles.

2. Related Background Art

Powder is used as a starting material for formation of ceramic and metal materials. The size and shape of the powder used affects the properties of the material that is formed. Powders with a variety of different sizes and shapes have therefore been proposed to provide required properties.

For example, in the field of dielectric materials that are used in materials for electronic parts, the trend toward compacting and shortening of electronic materials has led to demands for micronization of the starting particles. However, the surface area of the particles increases in an inversely proportional manner with respect to the particle size, and especially with submicron particles having particle sizes of 1 μm or smaller, reactivity increases as well due to the larger specific surface area. Therefore, such microparticles, in their ordinary state, tend to aggregate due to liquid bridge by humidity in the air, or due to Van der Waals forces or electrostatic attraction by electrostatic charges. When the particles undergo such aggregation, the effect is lost even though the individual particles are micronized, and it becomes difficult to form a material satisfying the required properties.

Methods for dispersing the aggregated particles are known, such as methods of applying ultrasonic waves in a liquid phase, methods of dispersion with surfactants, and methods of dispersion by c-potential.

In Japanese Patent Public Inspection No. 2008-530257 (hereinafter referred to as “Patent document 1”), it is attempted to improve the dispersibility of particles in a polymer such as a hydrocarbon, by covering the surfaces of the particles.

### SUMMARY OF THE INVENTION

However, all of these dispersion methods involve dispersion of the particles in a liquid phase. For example, the particles obtained by the method of Patent document 1 have a covering with a reactive functional group such as hydroxyl or a halogen, and therefore in the gas phase, liquid bridge may take place between the particles as adhesion of moisture occurs, or hydrogen bonding may occur. With the method of Patent document 1, therefore, it has been difficult to adequately inhibit aggregation of particles in the gas phase.

It is an object of the present invention, which has been accomplished in light of these circumstances, to provide a method for producing covered particles which have sufficiently excellent dispersibility in gas phase.

In order to achieve this object, the invention provides a method for producing covered particles, comprising: a mixing step of mixing a fluid containing particles comprising at least one type of substance selected from among metals, metal oxides and ceramics, a silsesquioxane having a functional group with an affinity for carbon dioxide, and supercritical carbon dioxide; and a covering step of reducing pressure of the fluid to gasify the supercritical carbon dioxide, while adhering the silsesquioxane onto the particles, and thereby obtaining covered particles comprising the particles and silsesquioxane covering the particles.

In the method for producing covered particles according to the invention, the fluid, which comprises the particles, the silsesquioxane having the functional group with an affinity for carbon dioxide and the supercritical carbon dioxide, is reduced in pressure to adhere the silsesquioxane to the particles and produce covered particles. The silsesquioxane having the functional group with an affinity for carbon dioxide dissolves in the supercritical carbon dioxide, thus functioning as a particle-dispersing agent in the fluid. Thus, particle dispersibility in the fluid is satisfactorily maintained in the mixing step. Since supercritical carbon dioxide is used in the subsequent covering step in which the pressure is reduced to obtain covered particles, it is possible for the silsesquioxane to adhere to the particles without an accompanying phase transition. Consequently, since aggregation does not occur with drying, the dispersibility of the particles in the fluid is not impaired, and covered particles with excellent dispersibility can be obtained. Moreover, the silsesquioxane having the functional group with an affinity for carbon dioxide, which covers the particle surfaces, has a water-repellent property and therefore liquid bridge between the covered particles by moisture in the air and other factors can be inhibited. In addition, since the covered material produces electrostatic repulsive force due to homopolar electrostatic charge between the covered particles, it is possible to inhibit aggregation between the covered particles in the gas phase. This effect allows production of covered particles with sufficiently excellent dispersibility.

The functional group with an affinity for carbon dioxide of the silsesquioxane used in the production method of the invention preferably include at least one of dimethylsiloxy groups and trimethylsiloxy groups. Such functional groups can result in even more satisfactory dispersibility of the particles in the fluid. Furthermore, since the electrostatic repulsive force can be increased while adequately inhibiting liquid bridge between the obtained covered particles, it is possible to obtain covered particles with even more excellent dispersibility.

The proportion of the functional group with an affinity for carbon dioxide with respect to the total functional groups in the silsesquioxane used in the production method of the invention is preferably 0.6 or greater. With such a large proportion of the functional group with an affinity for carbon dioxide, the solubility in supercritical or subcritical carbon dioxide is increased, and the function as a dispersing agent in supercritical or subcritical carbon dioxide allows covered particles with even more excellent dispersibility to be obtained.

According to the invention it is possible to provide a method for producing covered particles which have sufficiently excellent dispersibility in gas phase.

### BRIEF DESCRIPTION OF THE DRAWINGS

FIG. 1 is a schematic cross-sectional view showing a preferred embodiment of covered particles according to the invention.

FIG. 2 is an electron microscope photograph of the covered particles of Example 1.

FIG. 3 is a graph showing the particle size distribution of the covered particles of Example 1.

FIG. 4 is an electron microscope photograph of the Ni particles of Comparative Example 1.

FIG. 5 is a graph showing the particle size distribution of the Ni particles of Comparative Example 1.

FIG. 6 is an electron microscope photograph of the covered particles of Comparative Example 2.

FIG. 7 is a graph showing the particle size distribution of the covered particles of Comparative Example 2.

FIG. 8 is a graph showing the particle size distribution of the covered particles of Comparative Example 3.

FIG. 9 is a graph showing the particle size distribution of the covered particles of Example 2.

FIG. 10 is a graph showing the particle size distribution of the ferrite particles of Comparative Example 5.

FIG. 11 is a graph showing the particle size distribution of the covered particles of Comparative Example 6.

FIG. 12 is a graph showing the particle size distribution of the covered particles of Example 3.

FIG. 13 is a graph showing the particle size distribution of the covered particles of Example 4.

FIG. 14 is a graph showing the particle size distribution of the spherical BaTiO₃ particles of Comparative Example 7.

### DESCRIPTION OF THE PREFERRED EMBODIMENTS

Preferred embodiments of the invention will now be explained with reference to the accompanying drawings where necessary. The method for producing covered particles of this embodiment comprises a mixing step of mixing a fluid containing particles comprising at least one type of substance selected from among metals, metal oxides and ceramics, a silsesquioxane having a functional group with an affinity for carbon dioxide, and supercritical carbon dioxide; and a covering step of reducing pressure of the fluid to gasify the supercritical carbon dioxide, while adhering the silsesquioxane onto the particles, and thereby obtaining covered particles comprising the particles and silsesquioxane covering the particles. Each of these steps will now be explained in detail.

In the mixing step, there are first prepared particles comprising at least one type of substance selected from among metals, metal oxides and ceramics, and a silsesquioxane having a functional group with an affinity for carbon dioxide.

The particles used may be commercially available metallic particles, metal oxide particles or ceramic particles. The particles may be prepared by a common method. The covering material used may be a commercially available silsesquioxane having a functional group with an affinity for carbon dioxide, or it may be prepared by a common method.

The silsesquioxane having the functional group with an affinity for carbon dioxide is preferably one that dissolves in supercritical carbon dioxide. This will provide an excellent function as a dispersing agent in the supercritical carbon dioxide-containing fluid. The term “a functional group with an affinity for carbon dioxide” used throughout the present specification refers to functional groups having affinity for carbon dioxide, such as fluorine-based functional groups or silicon-based functional groups, and they preferably include siloxy groups. The siloxy groups may be optionally substituted. The functional group with an affinity for carbon dioxide more preferably include at least one of dimethylsiloxy groups and trimethylsiloxy groups, from the viewpoint of further increasing the dispersibility of the covered particles in air.

Silsesquioxanes having a functional group with an affinity for carbon dioxide include polysiloxanes with the repeating unit (RSiO_{1.5})ₙ. In this repeating unit, R represents a monovalent functional group with an affinity for carbon dioxide and n is preferably an integer of 6-10.

Preferred among such silsesquioxanes are (RSiO_{1.5})₈ and (RSiO_{1.5})₁₀, which have a complete cage structure, and those having an incomplete cage structure [(RSiO_{1.5})_{w} (RXSiO_{1.0})_{y}]_{Σz} (w=4, y=3, z=7). In these chemical formulas, each R represents a monovalent functional group with an affinity for carbon dioxide, and X is a monovalent reactive functional group. A silsesquioxane having such a structure is structurally stable and thus allows the excellent dispersibility of the covered particles to be more stably maintained.

When a silsesquioxane having a complete cage structure is used, the electrostatic repulsive force produced between the covered particles can be increased even further. Covered particles with even more excellent dispersibility can thus be obtained.

Examples of the monovalent reactive functional groups in the silsesquioxane include hydroxyl groups, halogen groups, alkoxide groups (—OR₁), acetate groups (—OOCR₂), peroxide groups (—OOR₃), amino groups and isocyanate groups. R₁-R₃ are monovalent organic groups different from the functional group with an affinity for carbon dioxide mentioned above.

For this embodiment, an increasing number of reactive functional groups in the silsesquioxane results in reaction between the silsesquioxane molecules covering the particle surfaces, and the silsesquioxane can thus cause aggregation between the covered particles. From this viewpoint, a smaller number of reactive functional groups in the silsesquioxane is preferred. Specifically, the proportion of the number of reactive functional groups with respect to the total functional groups in the silsesquioxane is preferably no greater than 0.4, more preferably no greater than 0.2 and even more preferably no greater than 0.1. From the same viewpoint, the silsesquioxane most preferably contains essentially no reactive functional groups.

On the other hand, from the viewpoint of obtaining more satisfactory dispersibility for the particles in fluids, the proportion of the number of functional groups with an affinity for carbon dioxide with respect to the total functional groups in the silsesquioxane is preferably 0.6 or greater, more preferably 0.8 or greater, even more preferably 0.9 or greater and most preferably 1. The silsesquioxane most preferably contains only functional groups with an affinity for carbon dioxide as the functional groups. Examples of such silsesquioxanes include (RSiO_{1.5})₈ and (RSiO_{1.5})₁₀ mentioned above, having a complete cage structure (where R represents a monovalent functional group with an affinity for carbon dioxide).

The silsesquioxane of this embodiment is not limited to the compounds mentioned above, and for example, it may be a silsesquioxane polymer having a random structure or ladder structure.

In the mixing step, the particles and the silsesquioxane having the functional group with an affinity for carbon dioxide are placed in a pressure resistant reactor. From the viewpoint of obtaining covered particles with more excellent dispersibility, the silsesquioxane content is preferably 0.01-1 parts by weight with respect to 10 parts by weight of the particles.

After sealing the reactor in which the starting materials have been placed, carbon dioxide is introduced into the reactor for pressurization until the carbon dioxide reaches a supercritical state, and the fluid in the reactor is stirred using a common stirrer or the like. During this time, the pressure and temperature in the reactor are set so that the carbon dioxide is in a supercritical state. For example, the pressure is 15-30 MPa and the temperature is 30-60° C. By stirring the supercritical carbon dioxide-containing fluid for 1-10 hours in the reactor under such conditions, it is possible to obtain a fluid in which the particles are dispersed in the supercritical carbon dioxide in which the silsesquioxane having the functional group with an affinity for carbon dioxide has dissolved. Because the silsesquioxane functions as a dispersing agent for the particles, satisfactory dispersibility between the particles in the fluid can be achieved.

In the covering step, the carbon dioxide is gradually vented from the reactor to reduce the pressure in the reactor. When this causes the pressure in the reactor to fall to the prescribed pressure, the supercritical carbon dioxide in the reactor becomes a gas and the silsesquioxane having the functional group with an affinity for carbon dioxide, which is dissolved in the supercritical carbon dioxide, adheres onto the particle surfaces. According to the production method of this embodiment, therefore, it is possible to adhere a silsesquioxane having a functional group with an affinity for carbon dioxide, as a dispersing agent dissolved in a fluid, onto particle surfaces, without phase transition between the liquid phase and gas phase, to obtain covered particles. It is thereby possible to obtain covered particles with the dispersed state of the particles satisfactorily maintained in the fluid. With the covered particles obtained by the production method of this embodiment, aggregation between the covered particles that occurs with drying can be prevented, compared to using conventional methods of obtaining covered particles by dispersion in a solvent. The covered particles obtained by the production method of this embodiment can therefore maintain excellent dispersibility even in gas phase.

The pressure reduction rate in the reactor during the covering step may be, for example, 10-50 MPa/hr. Pressure reduction in the reactor at this pressure reduction rate allows covered particles to be obtained having a silsesquioxane-containing covering layer formed in an approximately uniform manner, without excessively lengthening the step.

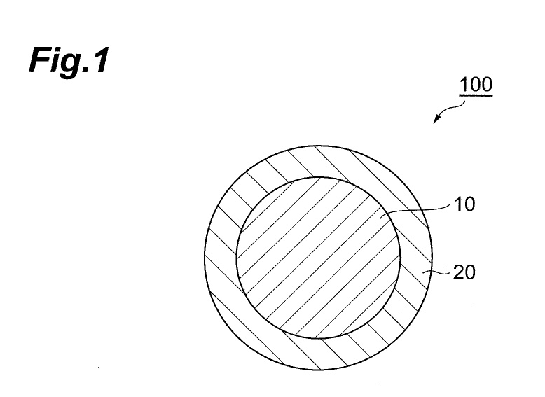

FIG. 1 is a schematic cross-sectional view showing covered particles obtained by the production method of this embodiment. Each of the covered particles 100 comprises a particle 10 as the core of the covered particle, and a covering material 20 covering the surface of the particle 10.

Examples of the material of the particles 10 include a metal material such as a simple metal or alloy, a metal oxide such as a ceramic, a ceramic other than a metal oxide, and a combination of the foregoing. For the field of electronic parts, the particles 10 are preferably magnetic particles of a base metal such as Ni, or of ferrite, or piezoelectric or dielectric particles (for example, particles containing a perovskite oxide), because of the demand, especially, for particles that are microsized and have excellent dispersibility. Using particles containing ferrite or the like that ordinarily tend to aggregate provides an even more notable effect of improving dispersibility.

The mean particle size of the particles 10 is preferably no greater than 1 μm, more preferably no greater than 0.5 μm and even more preferably no greater than 0.2 μm. Since the covered particles 100 of this embodiment have a covering material 20, it is possible to adequately inhibit aggregation between the covered particles 100 even with small particles 10.

The covered particles 100 have a covering material 20 that covers the entire surfaces of the particles 10. The covering material 20 comprises a silsesquioxane having a functional group with an affinity for carbon dioxide, and it is formed in a laminar fashion on the surfaces of the particles 10.

The thickness of the covering material 20 formed in a laminar fashion on the particles 10 is preferably 1-50 nm, more preferably 2-20 nm and even more preferably 3-10 nm. If the thickness of the covering material 20 layer is too small, it may be difficult to obtain sufficiently excellent dispersibility. If the thickness of the covering material 20 layer is too large, on the other hand, the proportion of the active ingredient (particles 10) in the material composing the covered particles 100 will be reduced, and the original function of the particles 10 may not be adequately exhibited.

Since the covered particles 100 have a layer of a covering material 20 comprising a silsesquioxane having a functional group with an affinity for carbon dioxide, which covers the particles, electrostatic repulsive force is produced between the covered particles 100. This can inhibit aggregation between the covered particles 100 and yield covered particles 100 with excellent dispersibility.

The embodiments described above are only preferred embodiments of the invention, and the invention is in no way limited thereto. For example, the covering material 20 does not need to have the entire surfaces of the particles 10 covered, as covered particles exhibiting the effect of the invention can be obtained if the surfaces of the particles 10 are only covered to an extent that the particles 10 do not contact each other. The structure may also have the covering material adhering in an interspersed manner, for example, on the surfaces of the particles 10.

### EXAMPLES

The present invention will now be explained in greater detail based on examples and comparative examples, with the understanding that the invention is in no way limited to the examples.

### Example 1

### <Preparation of Covered Particles>

In a reactor there were placed 10 g of commercially available spherical Ni particles (mean particle size: 0.5 μm) and 0.25 g of commercially available octa(hydridodimethylsiloxy)silsesquioxane ([(RSiO_{1.5})₈], R: —O—Si(CH₃)₂-H, molecular weight: 1018). Carbon dioxide was introduced into the reactor for pressurization in the reactor, and the carbon dioxide was brought to a supercritical state (temperature: 40° C., 25 MPa). The fluid containing the supercritical carbon dioxide, Ni particles and octa(hydridodimethylsiloxy)silsesquioxane in the reactor was stirred for 2 hours using a commercially available stirrer, while maintaining the same temperature and pressure conditions. During the stirring, the octa(hydridodimethylsiloxy)silsesquioxane dissolved into the supercritical carbon dioxide.

The carbon dioxide was then vented from the reactor to gradually lower the pressure while maintaining the same temperature in the reactor, the carbon dioxide was converted from the supercritical state to a gas phase, and the octa(hydridodimethylsiloxy)silsesquioxane was adhered onto the surfaces of the Ni particles. After lowering the pressure in the reactor to atmospheric pressure, covered particles were obtained from the reactor, having Ni particles and octa(hydridodimethylsiloxy)silsesquioxane covering the Ni particles.

### <Evaluation of Dispersibility>

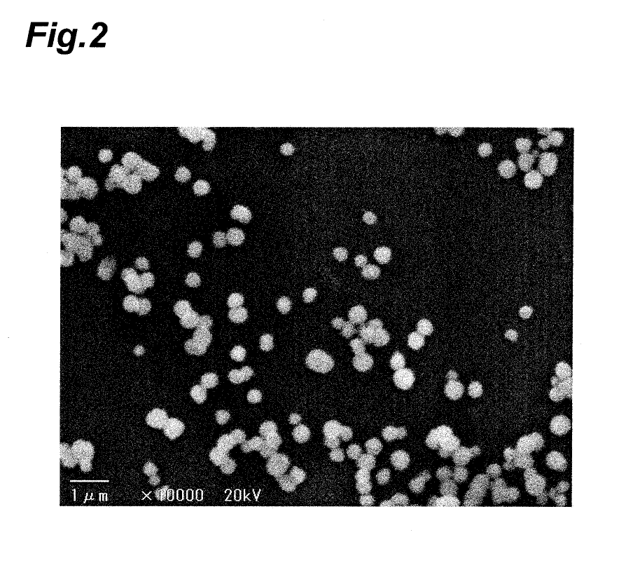

The obtained covered particles were observed with a scanning electron microscope (SEM, 10,000× magnification). FIG. 2 is an electron microscope photograph of the covered particles of Example 1. From this photograph it was confirmed that the covered particles of Example 1 had sufficiently excellent dispersibility in gas phase.

The dispersibility of the obtained covered particles in gas phase was evaluated using a laser diffraction particle size distribution measuring apparatus equipped with an airflow-type dispersion unit (trade name: HELOS by Sympatec). Specifically, 0.2 g of covered particles was introduced into the dispersion unit of the apparatus, the particle size distribution was measured with compressed air pressures of 0.1 MPa and 0.2 MPa, and the dispersibility was evaluated.

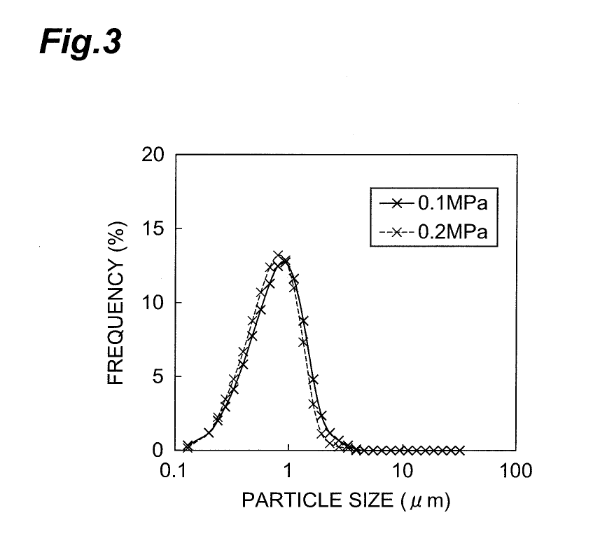

FIG. 3 is a graph showing the particle size distribution of the covered particles of Example 1. The particle size distribution was monodisperse regardless of the compressed air pressure, thus confirming sufficiently excellent dispersibility in gas phase.

### Comparative Example 1

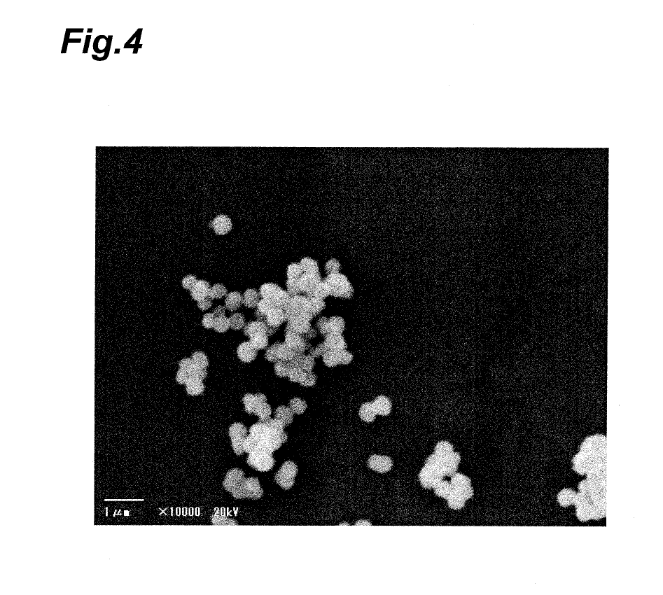

The dispersibility of commercially available spherical Ni particles was evaluated in the same manner as Example 1. FIG. 4 is an electron microscope photograph of the Ni particles of Comparative Example 1. This photograph confirmed aggregation of the Ni particles of Comparative Example 1 which had no covering material on the surface.

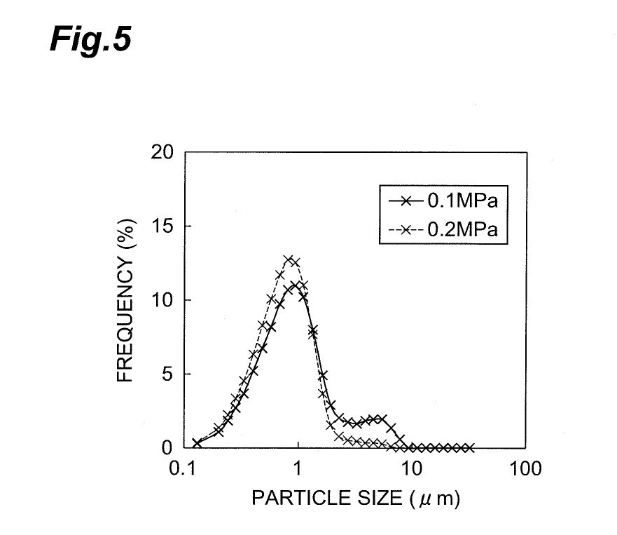

FIG. 5 is a graph showing the particle size distribution of the Ni particles of Comparative Example 1. This confirmed that, although the particle size distribution was monodisperse at a compressed air pressure of 0.2 MPa, a peak was present indicating aggregation between the Ni particles at a pressure of 0.1 MPa.

### Comparative Example 2

Covered particles were obtained in the same manner as Example 1, except for using a methylphenyl-based silicone resin (trade name: SILRES H44 by Wacker Asahi Kasei Silicone Co., Ltd.) instead of octa(hydridodimethylsiloxy)silsesquioxane. The dispersibility was evaluated in the same manner as Example 1.

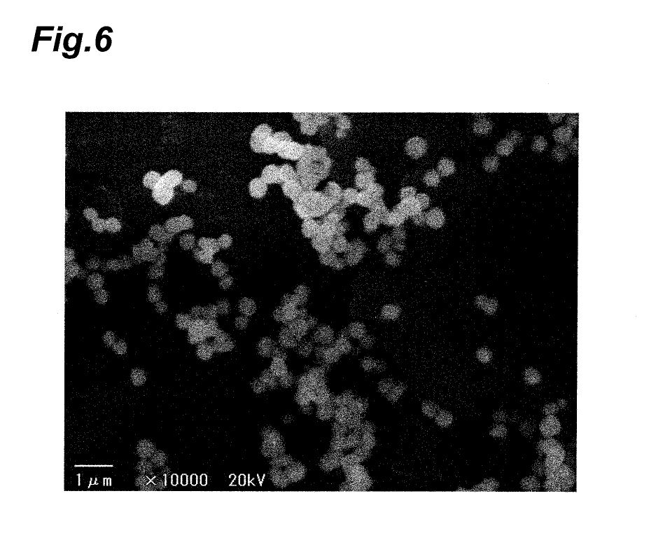

FIG. 6 is an electron microscope photograph of the covered particles of Comparative Example 2. The photograph confirmed aggregation of the covered particles of Comparative Example 2, which were covered with a silicone resin different from a silsesquioxane having a functional group with an affinity for carbon dioxide.

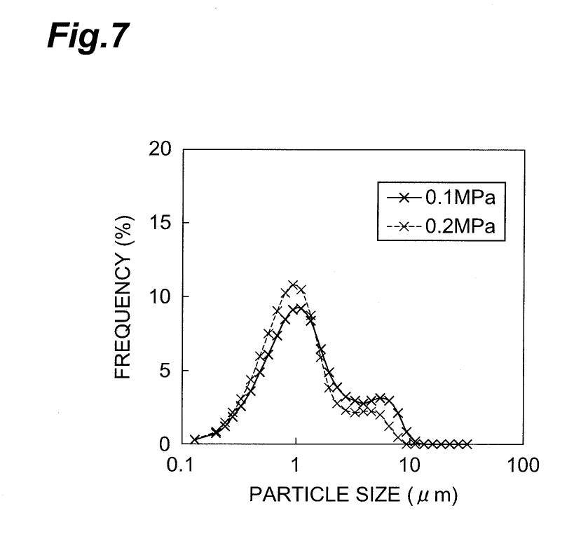

FIG. 7 is a graph showing the particle size distribution of the covered particles of Comparative Example 2. The particle size distribution was not monodisperse, and a peak was confirmed indicating strong aggregation between the covered particles, regardless of the compressed air pressure. This was presumably because the Ni particles were not sufficiently dispersed in the fluid, and a layer of the covering material (silicone resin) had formed in the aggregated state.

### Comparative Example 3

Covered particles were obtained in the same manner as Example 1, except for using octa(tetramethylammonium)silsesquioxane [(RSiO_{1.5})₈], R: —NH₄⁺(CH₃)₄⁻, molecular weight: 1137.8) instead of octa(hydridodimethylsiloxy)silsesquioxane. The dispersibility was evaluated in the same manner as Example 1.

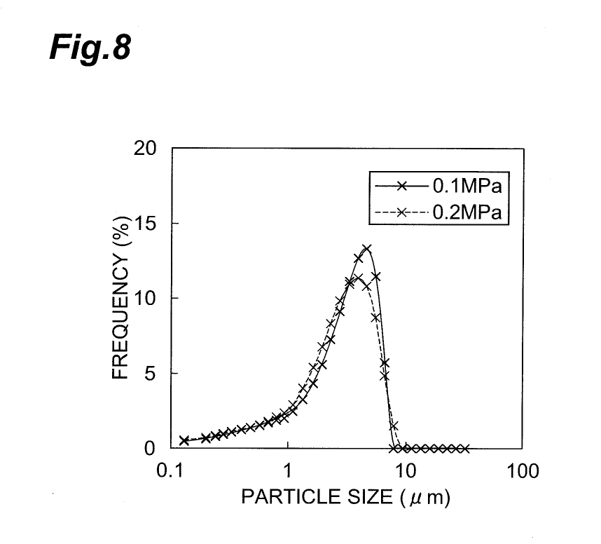

FIG. 8 is a graph showing the particle size distribution of the covered particles of Comparative Example 3. The particle size distribution of the covered particles of Comparative Example 3 had a change in peak form with variation of the dispersion pressure due to compressed air, thus confirming aggregation of the covered particles of Comparative Example 3.

### Comparative Example 4

A mixture was obtained by addition of 0.25 g of octaphenylsilsesquioxane ([(RSiO_{1.5})₈], R: phenyl, molecular weight: 1033.5) instead of octa(hydridodimethylsiloxy)silsesquioxane, to supercritical carbon dioxide in the same state as Example 1 (40° C., 25 MPa), but the octaphenylsilsesquioxane did not dissolve. It was therefore impossible to obtain covered particles.

### Example 2

Covered particles were obtained in the same manner as Example 1, except for using metal oxide particles (ferrite particles, mean particle size: 0.3 μm) instead of spherical Ni particles. The dispersibility was evaluated as follows, in the same manner as Example 1.

The dispersibility of the obtained covered particles in gas phase was evaluated using the same apparatus as in Example 1. The evaluation was conducted by measuring the particle size distribution of the covered particles with compressed air pressures of 0.1 MPa and 0.5 MPa. The dispersibility was evaluated by comparing the particle size distributions at each compressed air pressure.

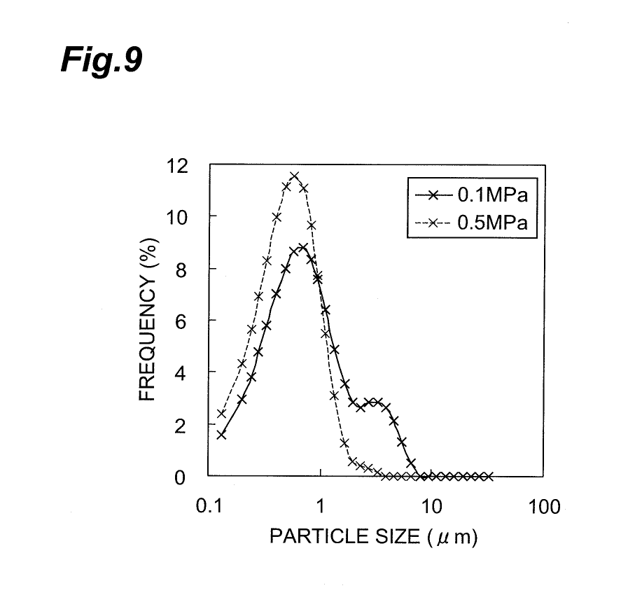

FIG. 9 is a graph showing the particle size distribution of the covered particles of Example 2. It was confirmed that the particle size distribution was monodisperse with a compressed air pressure of 0.5 MPa. That is, aggregation was confirmed to readily dissolve with the covered particles of Example 2. Even with a compressed air pressure of 0.1 MPa, it was confirmed that the dispersibility of the particles was greatly improved compared to particles without adhesion of a covering material (Comparative Example 5).

### Comparative Example 5

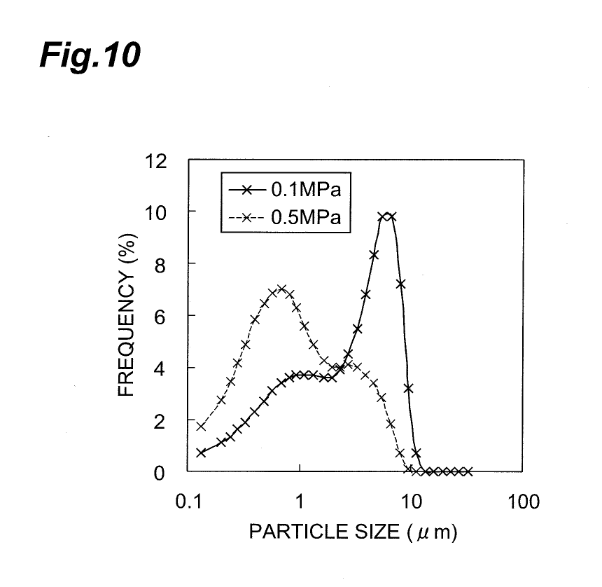

The dispersibility of the metal oxide particles used in Example 2 (ferrite particles, mean particle size: 0.3 μm) was evaluated in the same manner as Example 2. FIG. 10 is a graph showing the particle size distribution of the ferrite particles of Comparative Example 5. The ferrite particles were confirmed to be very densely aggregated compared to the covered particles of Example 2 which had a covering material.

### Comparative Example 6

Covered particles were obtained in the same manner as Example 2, except for using a methylphenyl-based silicone resin (trade name: SILRES H44 by Wacker Asahi Kasei Silicone Co., Ltd.) instead of octa(hydridodimethylsiloxy)silsesquioxane. The dispersibility was evaluated in the same manner as Example 2.

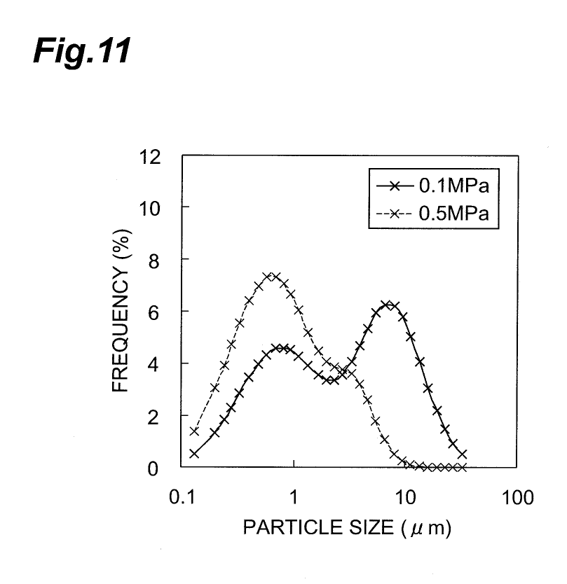

FIG. 11 is a graph showing the particle size distribution of the covered particles of Comparative Example 6. Peaks confirming aggregation of the covered particles were observed with both compressed air pressures of 0.1 MPa and 0.5 MPa. This was presumably because the metal oxide particles were not sufficiently dispersed in the fluid, and a covering material layer had formed in the aggregated state.

### Example 3

Covered particles were obtained in the same manner as Example 1, except for using commercially available octa(trimethylsiloxy)silsesquioxane ([(RSiO_{1.5})₈], R: —O—Si(CH₃)₃) as the covering material instead of octa(hydridodimethylsiloxy)silsesquioxane. The dispersibility was evaluated in the same manner as Example 1. During the stirring, the octa(trimethylsiloxy)silsesquioxane dissolved into the supercritical carbon dioxide.

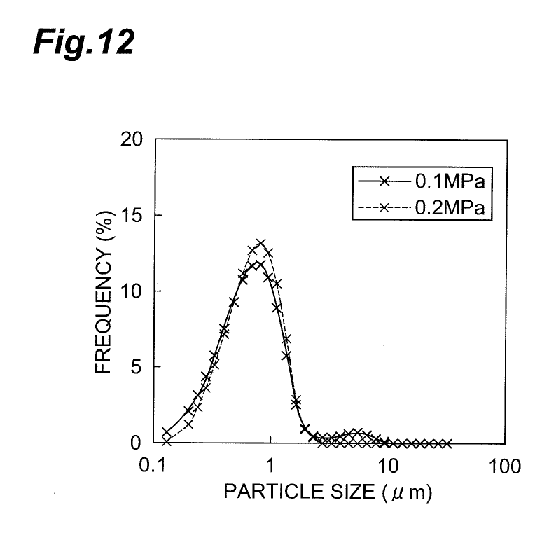

FIG. 12 is a graph showing the particle size distribution of the covered particles of Example 3. A drastic improvement in the dispersibility of the particles in the gas phase was confirmed, compared to the Ni particles of Comparative Example 1 which had no covering material (FIG. 5).

### Example 4

Covered particles were obtained in the same manner as Example 1, except for using commercially available spherical BaTiO₃ particles (mean particle size: 0.5 μm) instead of spherical Ni particles. The dispersibility was evaluated in the same manner as Example 2.

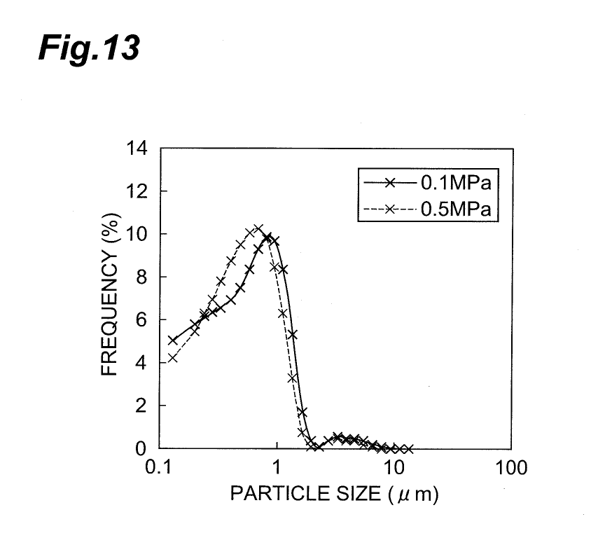

FIG. 13 is a graph showing the particle size distribution of the covered particles of Example 4. The covered particles of Example 4 were confirmed to have excellent dispersibility in gas phase, compared to particles without adhesion of a covering material (Comparative Example 7).

### Comparative Example 7

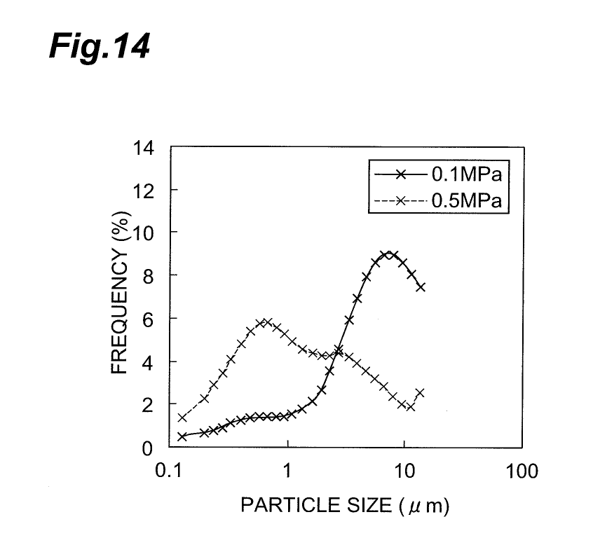

The dispersibility of the spherical BaTiO₃ particles used in Example 4 was evaluated in the same manner as for the covered particles of Example 4. FIG. 14 is a graph showing the particle size distribution of the spherical BaTiO₃ particles of Comparative Example 7. The spherical BaTiO₃ particles were confirmed to be very densely aggregated, compared to the covered particles of Example 4 which had a covering material.

What is claimed is:

1. A method for producing covered particles, comprising:
a mixing step of mixing a fluid containing particles comprising at least one type of substance selected from among metals, metal oxides and ceramics, a silsesquioxane having a functional group with an affinity for carbon dioxide, and supercritical carbon dioxide; and
a covering step of reducing pressure of the fluid to gasify the supercritical carbon dioxide, while adhering the silsesquioxane onto the particles, and thereby obtaining covered particles comprising the particles and silsesquioxane covering the particles.

2. The method according to claim 1, wherein the functional group with an affinity for carbon dioxide include at least one of dimethylsiloxy groups and trimethylsiloxy groups.

3. The method according to claim 1, wherein the proportion of the functional group with an affinity for carbon dioxide with respect to the total functional groups in the silsesquioxane is 0.6 or greater.
